(19) United States
(12) Patent Application Publication
(10) Pub. No.: US 2018/0045628 A1
(43) Pub. Date: Feb. 15, 2018

(54) IDENTIFICATION OF A TAGGED LIQUID

(71) Applicant: TruTag Technologies, Inc., Kapolei, HI (US)

(72) Inventors: Sergey Etchin, Castro Valley, CA (US); Hod Finkelstein, Berkeley, CA (US); Mark Hsu, Richmond, CA (US); Craig Leidholm, Kailua, HI (US); Michael P. O'Neill, Kaneohe, HI (US); Eryn Sacro, Salt Lake City, UT (US)

(21) Appl. No.: 15/666,397

(22) Filed: Aug. 1, 2017

Related U.S. Application Data
(60) Provisional application No. 62/371,972, filed on Aug. 8, 2016.
(60) Provisional application No. 62/470,064, filed on Mar. 10, 2017.

(51) Int. Cl. G01N 1/40; G01N 21/25; G01N 21/55; G01N 1/38

(52) U.S. Cl. CPC G01N 1/4077; G01N 1/38; G01N 21/255; G01N 21/55

(57) ABSTRACT

A device for identification of a tagged liquid includes a liquid access port, a powder access port, a filter and an optical analyzer. The liquid access port is for receiving a liquid. The powder access port is for receiving a powder. The powder includes tags. The filter is for separating one or more tags from a solution of the liquid mixed with the powder. The optical analyzer is for evaluating the one or more tags to verify the solution.

### CROSS REFERENCE TO OTHER APPLICATIONS

This application claims priority to U.S. Provisional Patent Application No. 62/371,972 entitled IDENTIFICATION OF A TAGGED LIQUID filed Aug. 8, 2016 which is incorporated herein by reference for all purposes. This application also claims priority to U.S. Provisional Patent Application No. 62/470,064 entitled CENTRIFUGAL ISOLATION FOR READING TAGS FROM SOLUTIONS filed Mar. 17, 2017 which is incorporated herein by reference for all purposes

### BACKGROUND OF THE INVENTION

Counterfeiting of high value goods is a common problem. Typically anything that can be sold is at risk of counterfeiting, particularly including high value goods like jewelry, perfume, medicine, food and drink, etc. Counterfeiting of medicine, food, and drink creates a particular risk, as the goods are ingested. Counterfeiting ingested goods not only creates a loss of value, it is potentially dangerous.

### BRIEF DESCRIPTION OF THE DRAWINGS

Various embodiments of the invention are disclosed in the following detailed description and the accompanying drawings.

FIG. 1 is a diagram illustrating an embodiment of a cross section of a cartridge for an instant liquid.

FIG. 2 is a diagram illustrating an embodiment of a system including a cartridge for an instant liquid just prior to liquid preparation.

FIG. 3 is a diagram illustrating an embodiment of a system including a cartridge for an instant liquid just after liquid preparation.

FIG. 4 is a diagram illustrating an embodiment of a system including a cartridge for an instant liquid in a configuration for a verification process.

FIG. 5 is a diagram illustrating an embodiment of a liquid preparation and verification machine.

FIG. 6 is a diagram illustrating an embodiment of a liquid preparation and verification machine.

FIG. 7 is a diagram illustrating an embodiment of a liquid comprising tags.

FIG. 8 is a diagram illustrating an embodiment of a liquid verification machine.

FIG. 9 is a diagram illustrating an embodiment of a liquid verification machine.

FIG. 10 is a block diagram illustrating an embodiment of a system for identification of a tagged liquid.

FIG. 11 is a block diagram illustrating an embodiment of a system for identification of a tagged liquid.

FIG. 12 is a block diagram illustrating an embodiment of a system for identification of a tagged liquid.

FIG. 13 is a flow diagram illustrating an embodiment of a process for identification of a tagged liquid.

FIG. 14 is a block diagram illustrating an embodiment of a system for identification of a tagged liquid.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A device for identification of a tagged liquid is disclosed. The device includes a liquid access port, a powder access port, a filter, and an optical analyzer. The liquid access port is for receiving a liquid. The powder access port is for receiving a powder, wherein the powder includes tags. The filter is for separating one or more tags from a solution of liquid mixed with powder. An optical analyzer is for evaluating the one or more tags to verify the solution.

Liquid or soluble goods can be securely tagged using an optical tag that produces a specific known interference pattern in response to stimulation with light. In the event the tags are made small enough and made from sufficiently inert materials, they can maintain the information stored in their interference pattern. In some embodiments, the liquid is to be ingested and the tags are regarded as safe to ingest. However, extracting a tag from the goods prior to consumption in order to verify the tag response can be challenging. A liquid can be tagged by mixing the tags with the liquid. In some embodiments, tags mixed with liquid can be read directly (e.g., by shining light through the liquid). In some embodiments, tags mixed with liquid cannot be read directly and are filtered out from the liquid in order to be measured. In various embodiments, liquids that can be tagged comprise alcoholic beverages, liquefied medicine, perfume, inks and dyes, energy drinks, baby formula, gasoline, etc. but also liquids with dissolved salt, sugar, spices, powder to kill bacteria in water, etc. In some embodiments, an instant liquid (e.g., liquids converted to powder by dehydration, a substance converted to powder through dehydration or other means, etc.) can be tagged prior to preparation by mixing tags with the instant liquid powder. In various embodiments, the liquid comprises a solution of a substance in a fluid, where the solution comprises a suspension, a colloid, a sol, a dispersion, or any other appropriate form of solution. In some embodiments, tags can be separated from the instant liquid powder when the liquid is prepared (e.g., by mixing with water). In some embodiments, the prepared liquid is able to pass through a filter into a receptacle, while the tags are held behind by the filter. The tags can then be evaluated. In various embodiments, instant liquid powders that can be tagged comprise instant liquid powders for baby formula, coffee, energy drinks, juice, soft drinks, medicine, sugar, salt, spices, gasoline additives, drinking water decontaminants, etc.

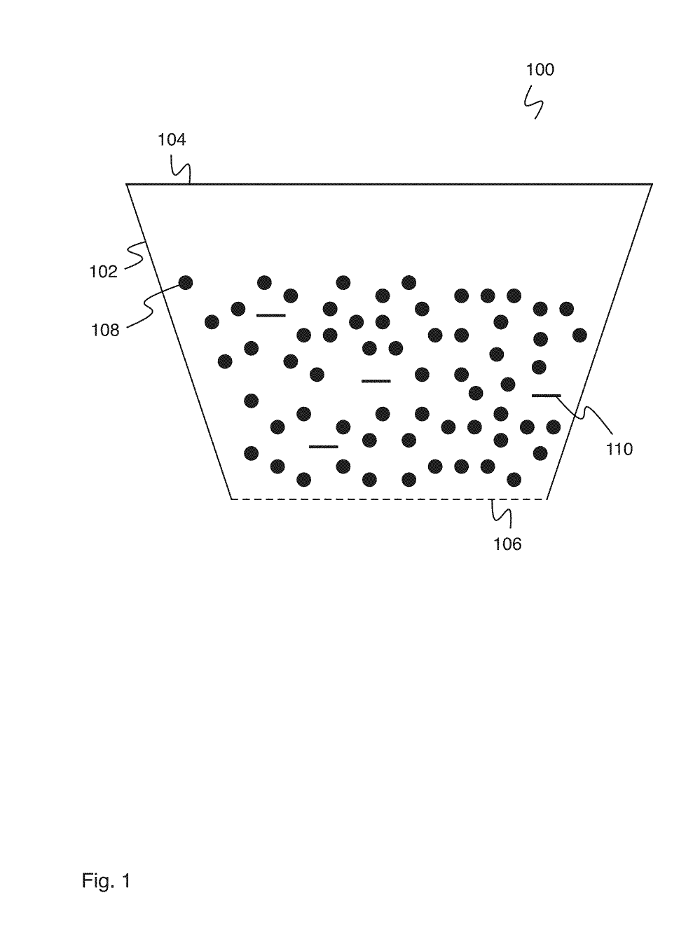

FIG. 1 is a diagram illustrating an embodiment of a cross section of a cartridge for an instant liquid. The cross-sectional view of the cartridge in FIG. 1 is from the point of view of the cartridge side. In the example shown, cartridge 100 comprises a cartridge for a tagged instant liquid. In some embodiments, cartridge 100 comprises the cross section of FIG. 1 revolved about a vertical line at the horizontal midpoint of the cross-section of cartridge 100 shown in FIG. 1. Cartridge 100 comprises cartridge body 102, comprising the sides of cartridge 100. In various embodiments, cartridge body 102 is comprised of stiff plastic, flexible plastic, metal, or any other appropriate material. In various embodiments, cartridge body 102 is desired to be light, inexpensive, impermeable to liquid, recyclable, sturdy, etc. In some embodiments, cartridge body 102 comprises one or more identifier labels (e.g., tags carrying optical information, tags carrying electrical information, tags carrying physical information, magnetic tags, QR codes, barcodes, etc.). Without loss of generality, such tags may carry information in the form of fluorescence in response to excitation illumination or chemical luminescence; or by virtue of their reflectance spectra such as Fabry-Perot or rugate reflections; or by having specific shapes or sizes; or by having specific colors such as quantum dots or flakes of paint or dye; or change in color with temperature change (thermochromic); or by a combination of the above. Alternately or in addition, such tags may carry information in the form of electrical information, for example, by having a range of resistivities or impedances, or dielectric properties; or by having structures or circuits that causes them to transmit electromagnetic information in response to an electrical, optical, or chemical stimulus. In some embodiments, tags carry information in the form of magnetic information (e.g., in the form of the existence of a magnetic field or magnetic or ferromagnetic particle, etc.). In some embodiments, tags carry information in the form of chemical information (e.g., in the form of specific affinity to certain chemical or biochemical probes or specific chemisorb or chemical reaction properties). In some embodiments, tags carry information in the form of thermal information (e.g., in the form of a change of phase at predetermined temperatures). In some embodiments, tags carry information in the form of opto-chemical information (e.g., by changing color in response to a chemical probe).

In the example shown, cartridge 100 comprises lid 104. In some embodiments, lid 104 is sealed over the top of cartridge body 102 after cartridge body 102 is filled. In some embodiments, lid 104 is sealed with glue (e.g., it is not resealable). In some embodiments, lid 104 is designed to be peeled off of cartridge body 102. In some embodiments, lid 104 is designed to be punctured by a liquid injector nozzle. In some embodiments, lid 104 is made from a material suitable for puncturing (e.g., thin plastic, foil, etc.). Cartridge 100 comprises filter 106. In various embodiments, filter 106 comprises a paper filter, a metal filter, a nylon filter, a polymer filter, glass/quartz fiber filters, polytetrafluoroethelyene (PTFE) filters, oil filters, or any other appropriate filter. In some embodiments, filter 106 comprises a filter chosen for flatness. In some embodiments, filter 106 comprises a cellulose filter (e.g., Whatman filter papers catalog no. 1004 125 #4 with 20-25 micron pore size). In some embodiments, the filter pore size is selected to be smaller than the average tag size. Cartridge 100 is filled with a mixture of instant liquid particles (e.g., instant liquid particle 108) and tags (e.g., tag 110). In some embodiments, the instant liquid particles comprise particles produced by dehydrating a liquid. In some embodiments, the instant liquid particles can dissolve in a liquid. In some embodiments, a liquid fills cartridge 100 rather than an instant liquid. In some embodiments, dissolving the instant liquid particles in a liquid produces a desired liquid. In some embodiments, the instant liquid particles comprise particles for producing a beverage. In various embodiments, the instant liquid particles comprise instant liquid particles for producing baby formula, coffee, energy drinks, juice, soft drinks, medicine, or any other appropriate liquid. In various embodiments, the tags comprise optical tags, electronic tags, magnetic tags, or any other appropriate tag technology as outlined above. In some embodiments, the tags comprise tags that produce a known optical light spectrum when illuminated with broadband light. In some embodiments, the tags comprise electrical tags (e.g., radio frequency identification tags, electronic article surveillance tags, etc.) that produce a known electromagnetic response when stimulated with electromagnetic energy. In some embodiments, the tags contain one entity which stores information and another entity which produces desirable physical and/or chemical properties such as ensuring that their size is larger than the pore size of a filter (e.g., the entity storing information is coated to make it larger or attached to a larger physical body as appropriate for the entity storing information and detection thereof). In various embodiments, ensuring that the tag is larger comprises encapsulation of particles with an edible coating (or not, as each case may be, as appropriate for the application), using a fluid bed device (e.g., a Wurster coating system), spray drying, granulation, ultrasonic coating, or via surface chemistry modifications to the particles (e.g., quantum dots—for example, gold and silver colloidal nanospheres, florescent markers) to functionalize the surface so as to allow attachment, and the growth of various molecules via mixing in an appropriate dispersion such as a solution, colloid, or suspension, or any other appropriate technique for ensuring that tags are larger than the pore size. Encapsulation of particles with a moisture-resistant coating (e.g., ethyl cellulose, polyvinyl alcohol, sodium alginate, titanium dioxide, etc.) may also serve the additional function to protect against infiltration of the nanoporous tag structure, allowing the determination of a tag's characteristic optical signature while the tags are still wet. Encapsulation methods to apply such protective coatings may include methods mentioned above or additionally via methods such as spinning disk encapsulation, vapor phase deposition (e.g., CVD or ALD), sol-gel and electroplating methods. In various embodiments, a separate chamber washes a reagent over some functionalized chemical markers (analytes) that have been added to the product and turns them a color (e.g., green like a litmus paper test), or produces bubbles, or some kind of visible response that a camera might observe, or any other appropriate technique.

In some embodiments, the tags are edible (e.g., the tags are made of inert materials and small enough to not damage the human body). In some embodiments, there are many more instant liquid particles than tags (e.g., one hundred times more, ten thousand times more, ten million times more, etc.). In some embodiments there are no instant liquid particles and the liquid either contains no particles, or contains fewer particles than the tags, which particles may be on the order of size of the tags or larger, or the liquid may contain any number of particles which are smaller than the tags and are smaller than the filter pore size. In some embodiments, the instant liquid particles are in the form of flakes. In some embodiments, the instant liquid particles are in the form of pellets. In some embodiments, the instant liquid particles are in the form of crystals. In some embodiments, the tags are in size range of 50 to 100 micrometers. In some embodiments, the instant liquid particles are in the size range of 1 to 100 micrometers. In some embodiments, the instant liquid particles are in the size range of 0.1 to 1 millimeters. In some embodiments the instant liquid particles are in the size range of 1 to 10 millimeters. In some embodiments, the filter holds the instant liquid particles and the tags prior to liquid preparation. In some embodiments, a removable label is placed over filter 106 to hold the instant beverage particles in the cartridge prior to preparation. In some embodiments, the filter pores are in the size range of 20 to 25 micrometers. In some embodiments, when the liquid is prepared, a liquid (e.g., water) is introduced into the cartridge, converting the instant liquid particles to a liquid that is then able to flow out through the filter. In some embodiments, when the liquid flows out of the cartridge through the filter, the tags are left behind, held by the filter. The left-behind tags can then be interrogated to determine the veracity and/or pedigree of the instant liquid powder.

In various embodiments, either instead of or in addition to the mechanical filtering of the tags, a magnetic field is used to collect the magnetic tags, either from solution or from the filter, and a measurement device, such as a camera, or a weight measurement device (e.g., a scale), or an electronic parameter measurement device (such as an ohmmeter or impedance meter) measures the existence and/or identity of the tags, and possibly interrogates them (e.g., with an RF field), or any other appropriate separation or interrogation technique.

In some embodiments, an alternating electric field preferentially aggregates or collects the tags either from solution or from the filter, based on their dipole moment (e.g., using dielectrophoresis) and a camera (e.g., detector) identifies the existence and identity of the tags.

In some embodiments, instead of being filtered, the liquid is distilled or evaporated, leaving behind the tags which are then imaged or otherwise interrogated.

In some embodiments, a tag comprises an identifier. In some embodiments, the tag comprises a rugate filter. In some embodiments a tag comprises a Fabry Perot filter. In some embodiments, the tag comprises a duality of rugate and Fabry Perot filters. In some embodiments the tag is dyed or colored. In some embodiments, the tags are formed with specific shapes or sizes (e.g., using photolithography, contact lithography or other methods). In some embodiments, tags are made of silica (deemed “generally recognized as safe”—or GRAS—by the FDA), rendering them biologically inert and edible. Each rugate tag contains a custom-manufactured spectral signature. The unique optical signature of each tag can be read by a low-cost scanner and linked to a label in a secure database, where additional information about the item can be stored, such as referencing an e-pedigree track-and-trace system. In some embodiments, tags comprise a silicon wafer that is etched to have a spectral code encoded by the etching. The wafer is divided into small tags, and the resultant tags contain a complex porous nanostructure that is programmed during electrochemical synthesis to display a unique reflectivity spectrum. The tags are then oxidized by a high-temperature bake step to turn the crystalline, nanoporous silicon tags into amorphous, nanoporous silica; or with lower temperatures and/or dwell times, into mixed-stoichiometry partially-oxidized silicon taggants composed of amorphous silicon dioxide and elemental silicon. This bake step stabilizes the nanoporous structure against further oxidation (thus stabilizing the spectral signature) and provides for the tags to be characterized as a GRAS excipient. In some embodiments, the spectrum of the filtered tags is measured via an integrated low-cost Fabry-Perot etalon-based reader. In some embodiments the spectrum is measured via an optical spectrometer-based reader. In some embodiments, the spectral peaks are observed via narrow-band illumination at a selected wavelength (for example, in the near infra-red), or set of wavelengths, by imaging the tags that reflect at those selected wavelength(s) with an inexpensive CMOS camera, or other type of sensor. The tags are passive, inconspicuous and can also be attached to the outside of packaging to be read, for example, through clear or translucent packaging or labels, as well as mixed directly into liquids or instant liquids as a forensic excipient.

In some embodiments, two or more types of tags are used as an identifier for the liquid or the powder that is used to make into a liquid.

In various embodiments, tags comprise non-oxidized silicon tags, partially-oxidized tags, fully-oxidized silicon tags, silicon-nitride tags, etched silicon tags with pores, or any other appropriate material composition for tags. In some embodiments, when the tags are wet and the nanoporous structure of the tags is infiltrated with liquid, non-oxidized silicon tags, partially-oxidized tags, and silicon-nitride tags, may offer more optical contrast to allow determination of a tag's characteristic optical signature in comparison to fully-oxidized tags.

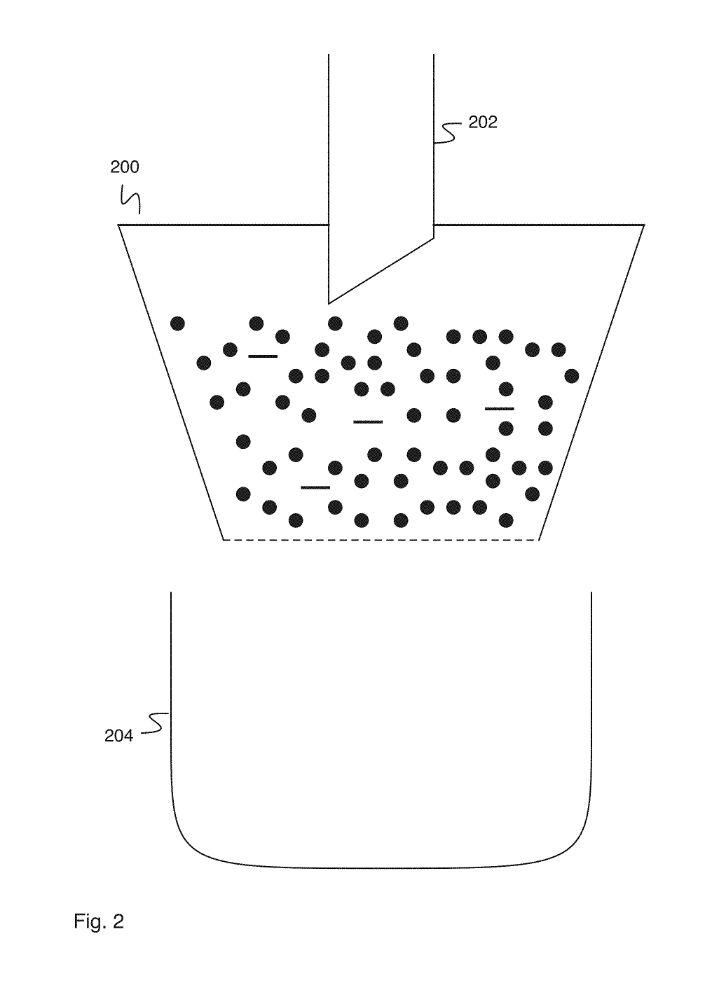

FIG. 2 is a diagram illustrating an embodiment of a system including a cartridge for an instant liquid just prior to liquid preparation. In some embodiments, cartridge 200 comprises cartridge 100 of FIG. 1 just prior to liquid preparation. In some embodiments, cartridge 200 has been placed into a liquid preparation and verification machine for liquid preparation and verification. In the example shown, the lid of cartridge 200 has been punctured by liquid injector 202. In some embodiments, liquid injector 202 comprises a tube with a sharp end for puncturing a cartridge lid. In the example shown, cartridge 200 is filled with a mixture of instant liquid particles and tags. After liquid injector 202 punctures the cartridge lid, a liquid is injected. In various embodiments, the liquid comprises water, milk, alcohol, acetone, or any other appropriate liquid or mixture of liquids. In some embodiments, the liquid is heated prior to injection. Receptacle 204 resides underneath cartridge 200 in order to receive a liquid comprised of liquid injected by liquid injector 202 with dissolved instant liquid powder. In some embodiments, liquid injector 202 and receptacle 204 comprise parts of a liquid preparation and verification machine. In some embodiments, receptacle 204 is locked by the liquid preparation and verification machine, preventing use of the prepared liquid until a verification step is complete. In some embodiments, receptacle 204 is used for testing purposes only and the sampled volume discarded.

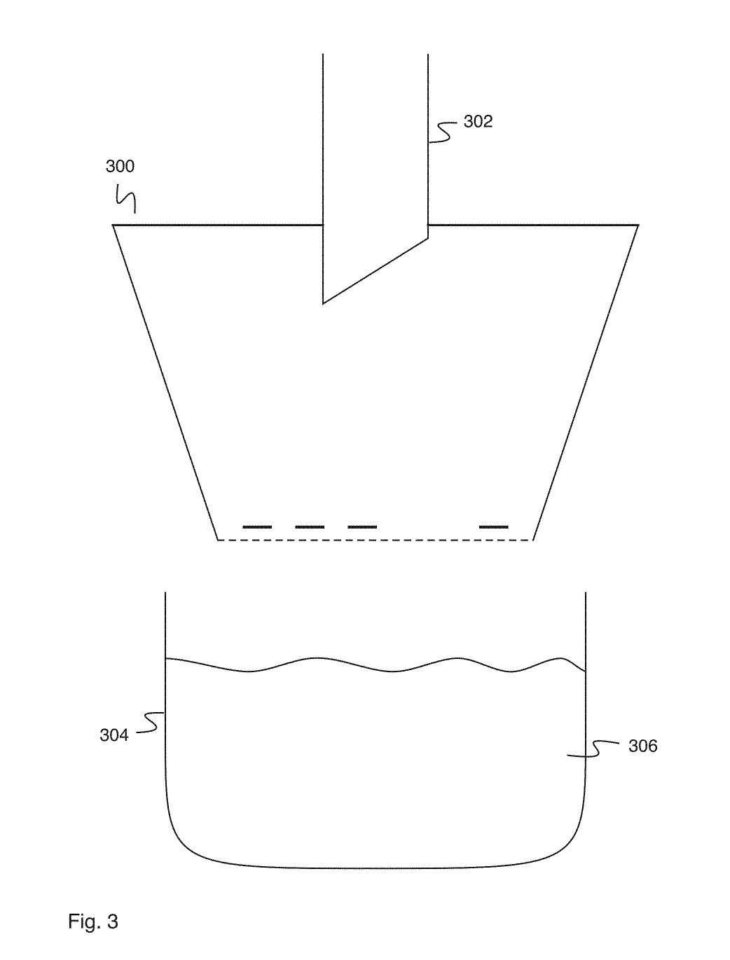

FIG. 3 is a diagram illustrating an embodiment of a system including a cartridge for an instant liquid just after liquid preparation. In some embodiments, cartridge 300 comprises cartridge 100 of FIG. 1 just after liquid preparation. In some embodiments, cartridge 200 has been placed into a liquid preparation and verification machine for liquid preparation and verification, and the liquid has been prepared. In some embodiments, liquid preparation comprises injection of a liquid by liquid injector 302 and collection of a prepared liquid by receptacle 304. Receptacle 304 comprises prepared liquid 306. In the example shown, cartridge 300 comprises tags (e.g., instant liquid particles have been dissolved and are now part of prepared liquid 306). In some embodiments, all instant liquid particles have been removed from cartridge 300. In some embodiments, a large fraction of instant liquid particles has been removed from cartridge 300 (e.g., 90% of the instant liquid particles that were present in cartridge 300 prior to liquid injection have been removed, 99% have been removed, 99.99% have been removed, etc.). In some embodiments, all tags remain in cartridge 300. In some embodiments, a large fraction of tags remains in cartridge 300 (e.g., 50% of the tags that were present in cartridge 300 prior to liquid injection remain, 90% of the tags remain, 99.5% of the tags remain, etc.). In some embodiments, after liquid preparation, tags lie flat on the filter at the bottom of cartridge 300.

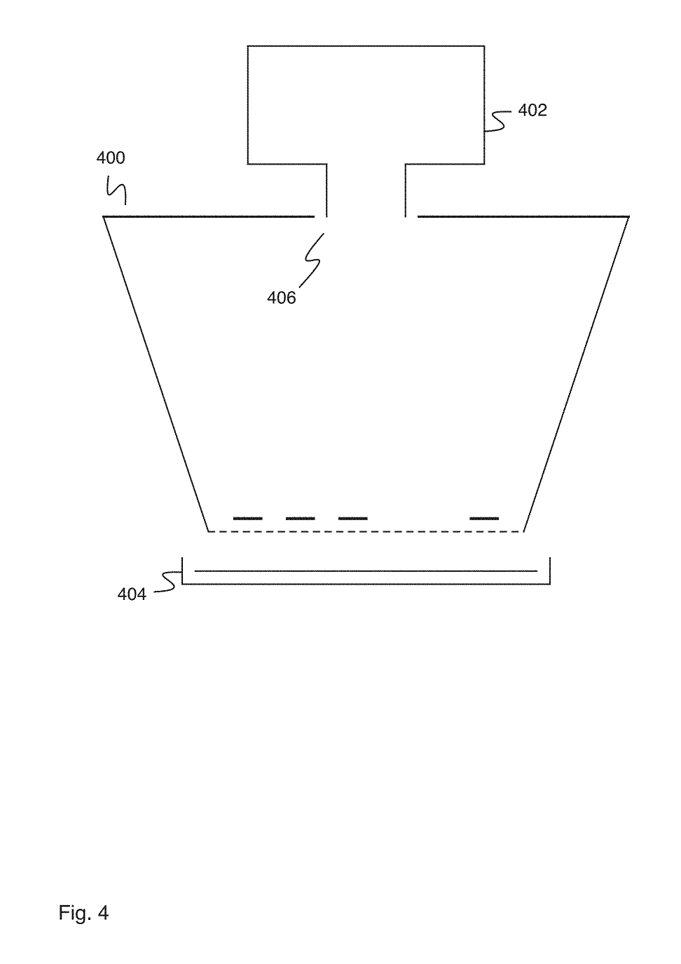

FIG. 4 is a diagram illustrating an embodiment of a system including a cartridge for an instant liquid in a configuration for a verification process. In some embodiments, cartridge 400 comprises cartridge 100 of FIG. 1 in a configuration for a verification process. In some embodiments, cartridge 400 has been placed into a liquid preparation and verification machine for liquid preparation and verification, liquid has been prepared, and cartridge 400 has been configured for a verification process. In some embodiments, preparing cartridge 400 for a verification process comprises removing cartridge 400 from the preparation location of the liquid preparation and verification machine and replacing cartridge 400 into a verification location of the liquid preparation and verification machine. In some embodiments, preparing cartridge 400 for a verification process comprises moving (e.g., manually or automatically) cartridge 400 within the liquid preparation and verification machine from a preparation location to a verification location. In some embodiments, preparing cartridge 400 for a verification process comprises moving (e.g., manually or automatically) liquid preparation hardware (e.g., a liquid injector and a receptacle) away from cartridge 400 and moving (e.g., manually or automatically) verification hardware (e.g., interrogator 402 and heater 404) to cartridge 400. In the example shown, interrogator 402 comprises an interrogator for interrogating tags. In some embodiments, interrogating tags comprises providing a stimulus to tags and receiving and analyzing a response. In various embodiments, the stimulus comprises an optical stimulus, an electromagnetic stimulus, a magnetic stimulus, or any other appropriate stimulus. In some embodiments, interrogator 402 comprises an optical interrogator that includes a broadband light source and an interferometer. In some embodiments, the interferometer comprises a Fabry-Perot interferometer. In some embodiments, the interferometer comprises a microelectromechanical system (e.g., MEMS). In some embodiments, interrogator 402 is able to read an encoded signal from tags left behind in cartridge 402. In some embodiments, the encoded signal comprises the optical response to broadband light. In some embodiments, the encoded signal comprises a set of optical peaks that encode information—for example, using peak locations and/or peak heights. In various embodiments, 1, 2, 3, 5, 7, 12, 24, 48 or any other number of bits of information can be read from the tags. In the example shown, interrogator 402 interrogates tags via hole 406. In some embodiments, hole 406 comprises a hole in a cartridge lid. In some embodiments, hole 406 comprises a hole produced by puncturing the lid of cartridge 400. In some embodiments, hole 406 is produced by a liquid injector as part of a liquid preparation step. In the example shown, heater 404 heats cartridge 400 prior to interrogation. In some embodiments, heating dries residual liquid from cartridge 400 that did not drain during liquid preparation. In some embodiments, removing liquid from cartridge 400 prior to verification increases the reliability of the verification.

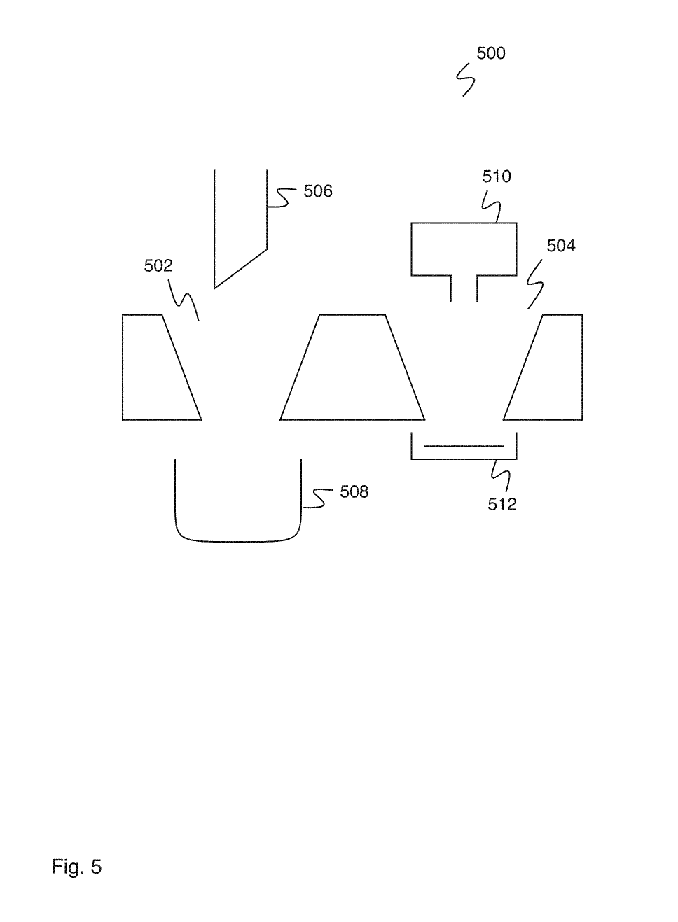

FIG. 5 is a diagram illustrating an embodiment of a liquid preparation and verification machine. In the example shown, liquid preparation and verification machine 500 comprises preparation location 502 and verification location 504. Liquid preparation and verification machine 500 comprises liquid injector 506 for injecting liquid into a cartridge in preparation location 502 and receptacle 508 for receiving prepared liquid from a cartridge in preparation location 502. Liquid preparation and verification machine 500 comprises interrogator 510 for interrogating tags of a cartridge in verification location 504 and heater 512 for heating a cartridge in verification location 504. In some embodiments, liquid preparation and verification machine 500 is operated by a user first placing a cartridge into preparation location 502, second indicating to the machine to prepare the liquid, third moving the cartridge from preparation location 502 to verification location 504, and fourth indicating to the machine to verify the cartridge. In some embodiments, after verification, liquid preparation and verification machine 500 indicates to a user whether the liquid passed verification.

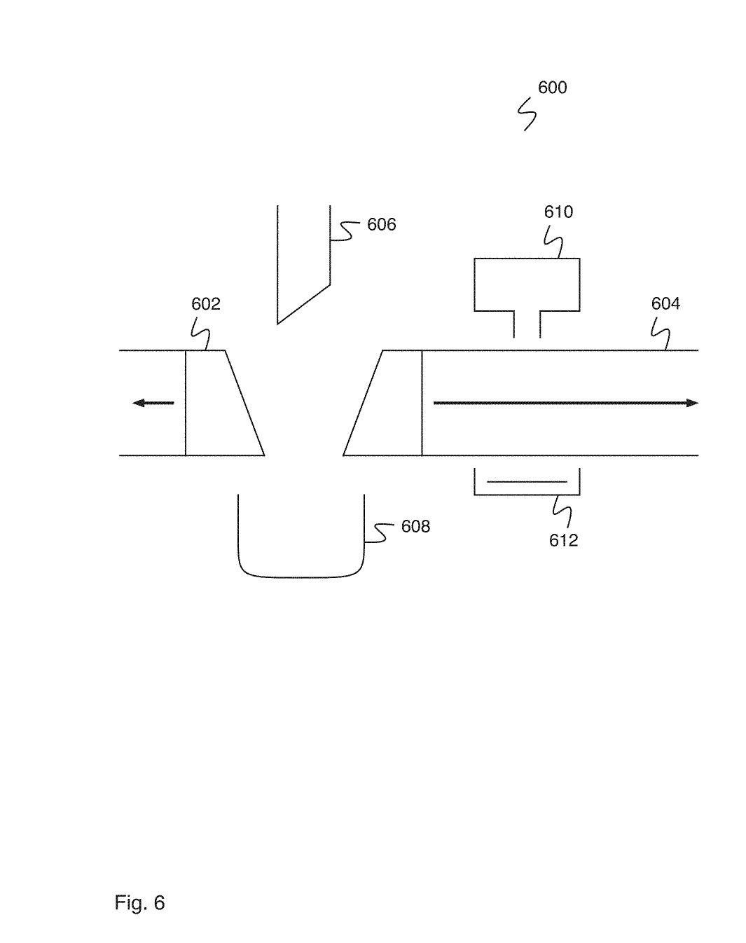

FIG. 6 is a diagram illustrating an embodiment of a liquid preparation and verification machine. In the example shown, liquid preparation and verification machine 600 comprises cartridge holder 602. Cartridge holder 602 is mounted on cartridge mover 604. In various embodiments, cartridge mover 604 comprises a cord for pulling cartridge holder 602 on a track, an air blower for blowing cartridge holder 602 on a track, a rotating disc, a moving post for pulling and cartridge holder 602, or any other appropriate cartridge mover for moving cartridge holder 602. In the example shown, cartridge mover 604 moves cartridge holder 602 between a preparation location and a verification location. Liquid preparation and verification machine 600 comprises liquid injector 606 for injecting liquid into a cartridge in the preparation location and receptacle 608 for receiving prepared liquid from a cartridge in the preparation location. Liquid preparation and verification machine 600 comprises interrogator 610 for interrogating tags of a cartridge in the verification location and heater 612 for heating a cartridge in the verification location. In some embodiments, liquid preparation and verification machine 600 is operated by a user first placing a cartridge into cartridge holder 602, and second indicating to the machine to prepare the liquid and verify the cartridge. Liquid preparation and verification machine 600 automatically prepares the liquid, moves the cartridge from the preparation location to the verification location, and verifies the cartridge. In some embodiments, after verification, liquid preparation and verification machine 600 indicates to a user whether the liquid passed verification.

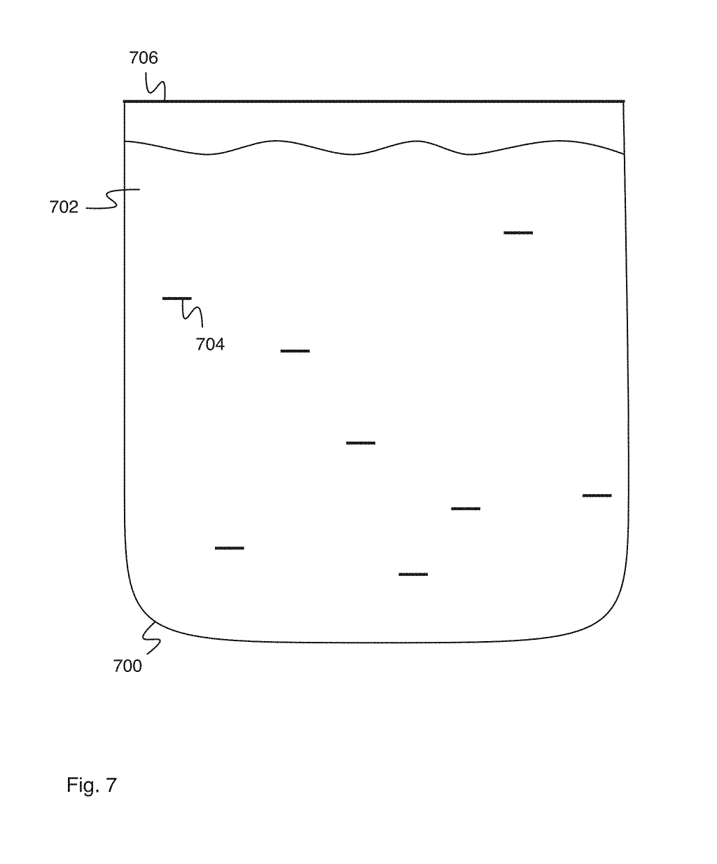

FIG. 7 is a diagram illustrating an embodiment of a liquid comprising tags. In the example shown, vessel 700 holds liquid 702 comprising one or more tags (e.g., tag 704). In some embodiments, liquid 702 comprises a valuable liquid (e.g., a liquid at risk of counterfeiting). In various embodiments, liquid 702 comprises an alcoholic beverage, a cooking oil, a baby formula, a perfume, a liquefied medicine, an ink, a dye, or any other appropriate liquid. In the example shown, vessel 700 is sealed with closure 706. In various embodiments, closure 706 comprises a seal, a resealable seal, a jar lid, a bottle cap, a reclosable beverage cap, or any other appropriate closure. In some embodiments, vessel 700 is designed to fit into a liquid verification machine. In some embodiments, vessel 700 is designed to cleanly pour liquid and reseal. In various embodiments, liquid 702 comprises tags at low through high tag densities (e.g., 0.1 tags/mL, 100 tags/mL, 10000 tags/mL, etc.).

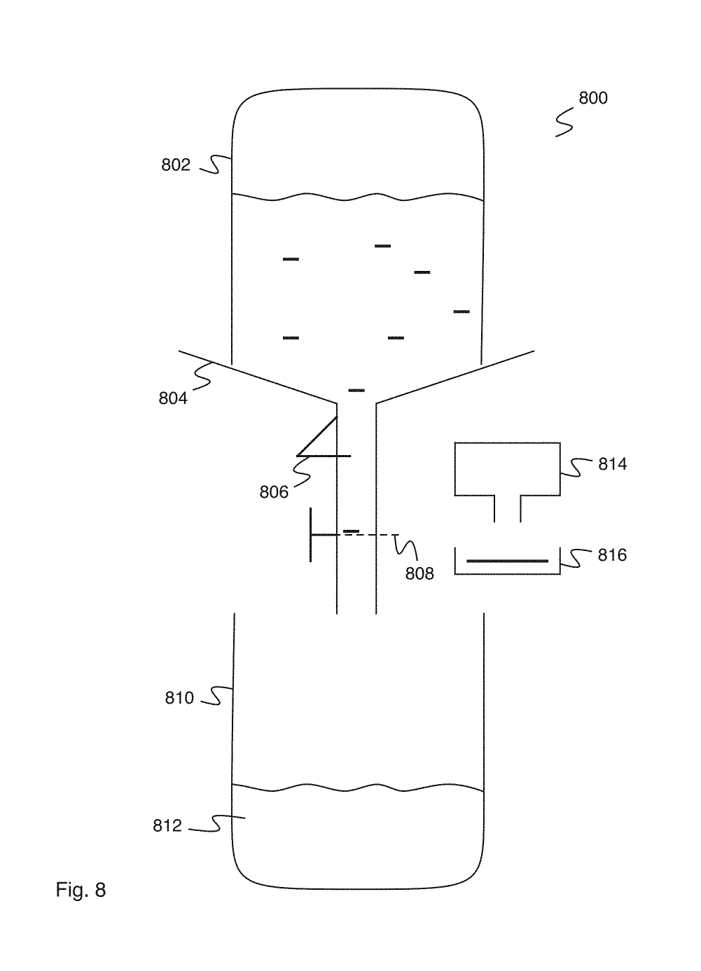

FIG. 8 is a diagram illustrating an embodiment of a liquid verification machine. In some embodiments, liquid verification machine 800 comprises a liquid verification machine for verifying a liquid comprising tags stored in a vessel (e.g., vessel 700 of FIG. 7). In the example shown, vessel 802 is placed into liquid verification machine 800 upside down with its closure removed. Liquid is guided through funnel 804 and valve 806. In some embodiments, funnel 804 comprises an inlet port for receiving a liquid. In the example shown, valve 806 is open and allows liquid to flow. Liquid flows through filter 808. In some embodiments, filter 808 does not allow tags to pass. Filtered liquid 812 is collected in receptacle 810 for usage. In some embodiments, filtered liquid 812 comprises no tags. In some embodiments, filtered liquid 812 comprises a small number of tags (e.g., 1% of the tag density of the liquid in vessel 802). In some embodiments, filter 808 can be moved (e.g., manually or automatically) between a filtering position and a verification position. In the example shown, filter 808 is in the filtering position. Liquid verification machine 800 comprises interrogator 814 for interrogating tags filtered by filter 808 and heater 816 for heating filter 808. In order for interrogator 814 and heater 816 to be used, filter 808 is first moved from the filtering position to the verification position. In some embodiments, before filter 808 can be moved to the verification position, valve 806 is closed (e.g., to prevent unfiltered liquid from draining into receptacle 810.

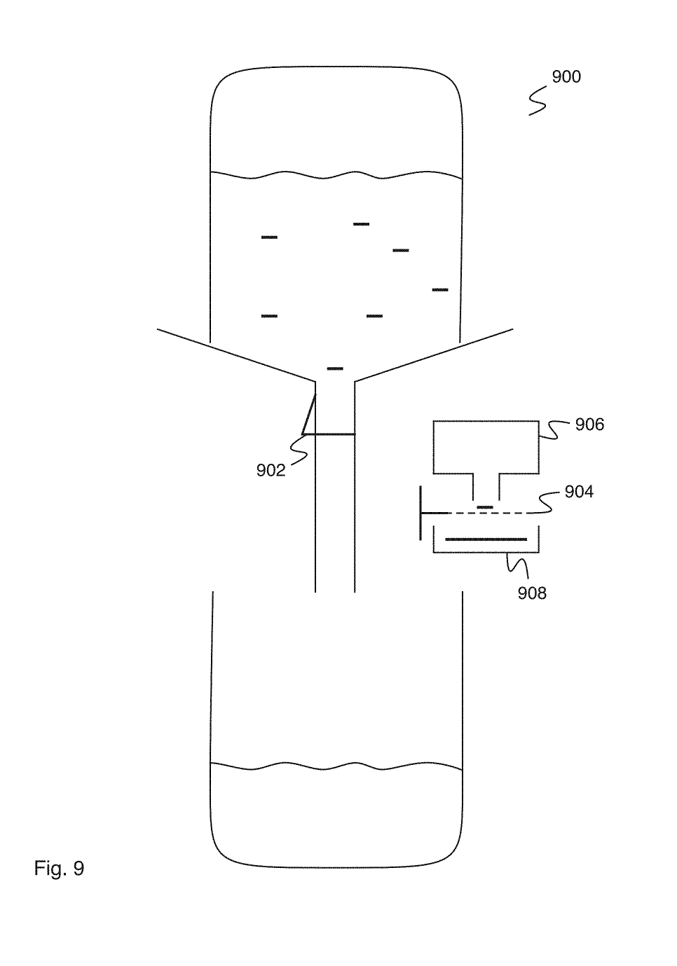

FIG. 9 is a diagram illustrating an embodiment of a liquid verification machine. In some embodiments, liquid verification machine 900 comprises liquid verification machine 800 with a filter (e.g., filter 904) in a verification position. In the example shown, valve 902 is closed. Filter 904 is in a verification position for drying by heater 908 and verification by interrogator 906. In some embodiments, after verification by interrogator 906, liquid verification machine 900 indicates to a user whether the liquid passed verification. In some embodiments, before drying, filter 904 is further rinsed to remove any insolubilized material that might remain on the filter and interfere with the readout of the tags. In some embodiments, various and multiple solvents and/or multiple rinses may be required to sufficiently dissolve and/or rinse away interfering material. In some embodiments, a solvent comprises an organic solvent (e.g., ethanol, acetone, methanol, acetonitrile, hexanes, diethyl ether, etc.) or acids (e.g., HCl, acetic acid, nitric acid, piranha, etc.) or bases (e.g., NaOH, KOH, etc.). In some embodiments, after verification, filter 904 is reusable and is washed to remove tags, in order to enable an accurate measurement the next time. In some embodiments, an interlock prohibits access to the filtered liquid until verification is passed.

In some embodiments, drying is achieved without heating. In various embodiments, drying is achieved using desiccant, vacuum, or any other appropriate drying method.

In some embodiments, separation of the tags from other particles in the liquid is achieved using centrifugal force where the liquid or a sample of the liquid is put in a centrifuge and the tags are separated (e.g., as being of a different density from the liquid) and then extracted (e.g., liquid poured off the top of a container after being centrifuged) and the tags optically read from the bottom of the container, or the tags are removed from the container by rinsing onto a plate or filter to be read either wet or after drying as applicable to the type of tag. In various embodiments, the tags are dried using heating, desiccant, vacuum, or any other appropriate drying method.

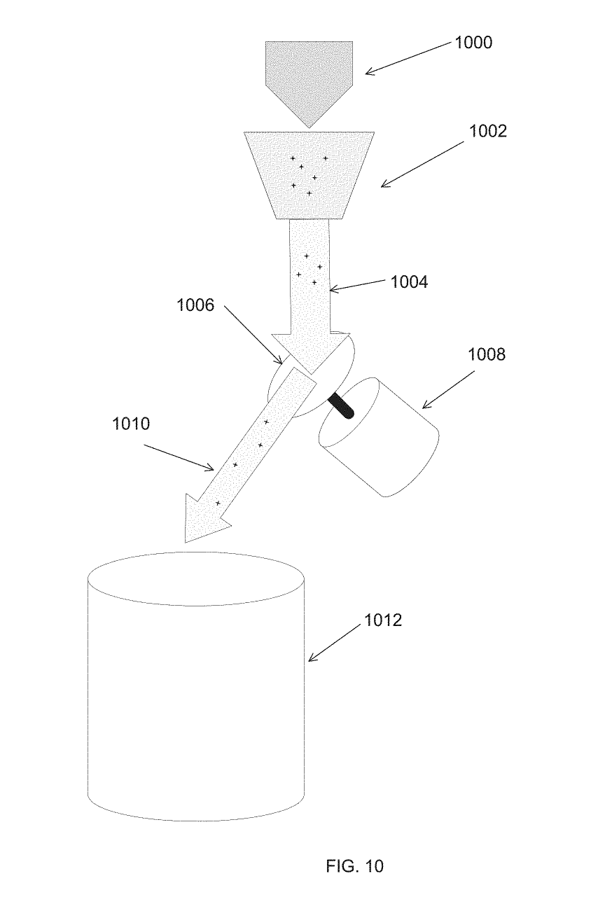

FIG. 10 is a block diagram illustrating an embodiment of a system for identification of a tagged liquid. In the example shown, water 1000 is input through pod or capsule 1002 that holds a powder for making a beverage. The powder also includes tags that are mixed into the powder. Solution 1004 is made up of powder in solution with the liquid and includes tags that are directed to flow over filter 1006 that traps some of the tags. Filter 1006 is mounted on motor 1008 capable of spinning filter 1006. Solution 1010 continues on to cup 1012.

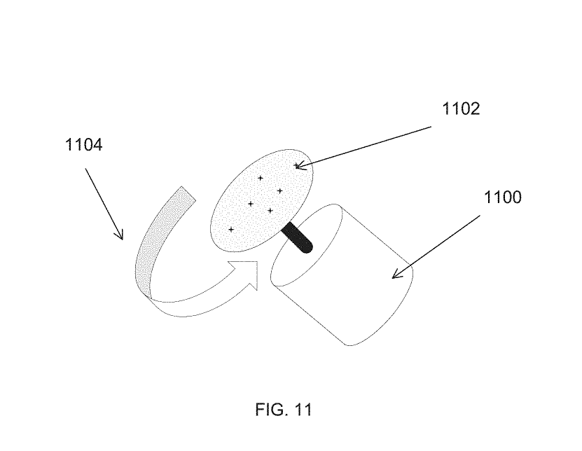

FIG. 11 is a block diagram illustrating an embodiment of a system for identification of a tagged liquid. In some embodiments, filter 1102 and motor 1100 are filter 1006 and motor 1008 of FIG. 10. In the example shown, after the tags have been trapped and the filter is no longer in the flowing stream of solution (e.g., either removed from the stream of solution or after the stream of solution has finished flowing), motor 1100 spins filter 1102 in direction 1104 at high speed to force the liquid off of filter 1102. The spinning drives off the liquid with centrifugal force without removing the tags as the tags stay stuck within the fibers of filter 1102.

In some embodiments, the solution from the cartridge is passed over a separate “tag capture” filter and then the filter moves under the optical head for interrogation. In some embodiments, the whole cartridge is spun and the cartridge is moved under the optical head for interrogation through an access hole. In some embodiments, the filter part of the cartridge is broken off, spun to remove liquid, and moved under the optical head for interrogation.

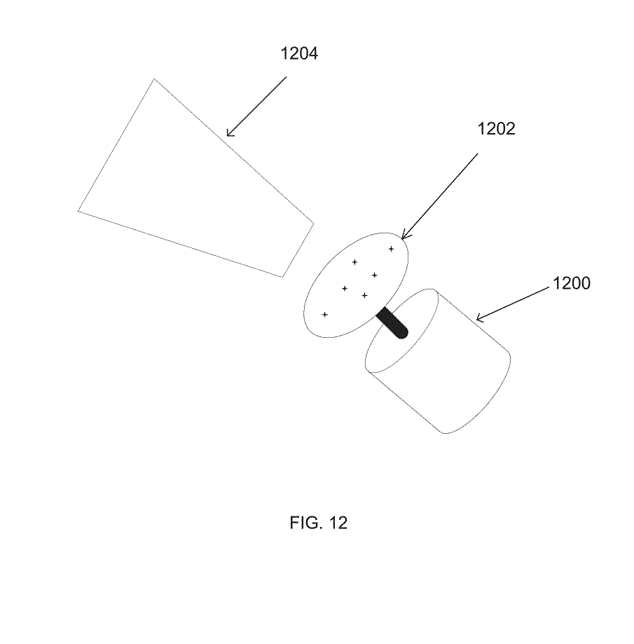

FIG. 12 is a block diagram illustrating an embodiment of a system for identification of a tagged liquid. In some embodiments, filter 1202 and motor 1200 are filter 1006 and motor 1008 of FIG. 10. In the example shown, reader head 1204 is used to read the tags optically to determine a characteristic optical signature. Reader head 1204 is positioned to be able to read tags on filter 1202, reader head 1204 is moved over to filter 1202, or filter 1202 is moved over to read head 1204.

In some embodiments, the interrogator is moved into position and the filter is stationary, and following interrogation, the interrogator is moved away and the filter is flushed. In some embodiments, there are two valves instead of one in order to properly flush the filter.

In some embodiments, the tags are read when wet so there is no drying process performed.

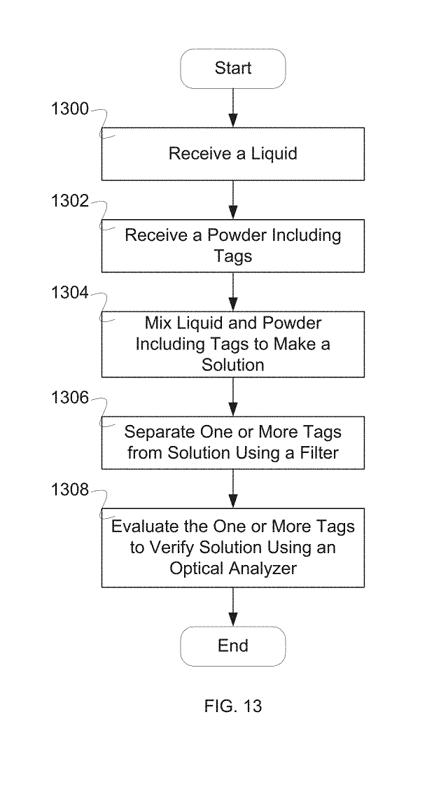

FIG. 13 is a flow diagram illustrating an embodiment of a process for identification of a tagged liquid. In some embodiments, the process of FIG. 13 is used to identify a tagged liquid using a device to verify the liquid. In the example shown, in 1300 a liquid is received. For example, a liquid is received in the device through an access port. In some cases, the liquid received is detected using a sensor and the signal is monitored using a processor. In 1302, a powder including tags is received. For example, a powder with tags is received in the device through an access port. In some cases, the powder received is detected using a sensor and the signal is monitored using a processor. In 1304, the liquid and the powder including tags are mixed to make a solution. For example, the liquid (e.g., water) is mixed or poured over the powder including tags to make a solution (e.g., baby formula, coffee, juice, energy drink, protein drink, medicine, etc.). In 1306, one or more tags are separated from solution using a filter. For example, the solution is poured over or through a filter, the filter separates some of the tags from the solution for evaluation, and the filter is prepared for evaluation (e.g., an optical analyzer is positioned relative to the filter or the filter is positioned relative to the optical analyzer, the filter is dried—for example, using heating or spinning, etc.). In 1308, the one or more tags are evaluated to verify the solution. For example, the one or more tags are evaluated to verify the solution by illuminating the filter and then looking for a reflected optical signal from the one or more tags. The reflected optical signal is sent to a processor and the reflected optical signal is compared to a stored database to determine whether the solution is to be authenticated. The tags are associated with a specific powder to make a specific solution and in the event that the signature matches the appropriate tags associated with the solution, then the processor indicates that the solution is verified.

In various embodiments, a cartridge (e.g., a disposable cartridge, a reusable cartridge, etc.) for an instant liquid comprises one or more of the following:
a cartridge body
a filter
   wherein the filter comprises pores in the range of 20 to 25 microns
   wherein the filter is made of paper
   wherein the filter is selected for flatness
a lid
   wherein the lid can be punctured by a liquid injector for injecting a liquid into the cartridge
   wherein the punctured lid comprises a hole for optical evaluation
a powder contained within the cartridge body, wherein the powder can dissolve in a liquid to produce a desired liquid
   wherein the desired liquid comprises baby formula
   wherein the desired liquid comprises coffee
   wherein the desired liquid comprises juice
   wherein the desired liquid comprises an energy drink
   wherein the desired liquid comprises a protein drink
   wherein the desired liquid comprises medicine
one or more identification tags mixed with the powder
   wherein the tags comprise optical identification tags
   wherein the tags are edible
   wherein the tags are not soluble
   wherein the tags are too large to pass through the filter
   wherein the tags are in the range of 50 to 100 microns.

In various embodiments, a system for preparing and evaluating a liquid comprises one or more of the following:
a cartridge receptacle for holding a cartridge
   wherein the cartridge receptacle is in a preparation location and the system comprises a second cartridge receptacle in a verification location
   wherein the cartridge receptacle moves between a preparation location and a verification location
   wherein the cartridge receptacle moves manually
   wherein the cartridge receptacle moves automatically
a liquid injector for injecting liquid into the cartridge
   wherein the liquid injector punctures a hole in the cartridge lid
a tag evaluator for verifying a tag
   wherein the tag evaluator optically verifies the tag
   wherein the tag evaluator optically verifies the tag via a punctured hole in the cartridge lid
   wherein the tag evaluator comprises a light source
   wherein the tag evaluator comprises a spectrometer
   wherein the tag evaluator comprises a Fabry-Perot interferometer
   wherein the tag evaluator comprises a microelectromechanical systems interferometer
a heater for drying a cartridge
   wherein the cartridge is dried prior to evaluation
a receptacle for collecting liquid
   wherein the receptacle is locked until the cartridge is verified
an indicator for indicating whether the cartridge passed verification.

In various embodiments, a system for evaluating a liquid comprises one or more of the following:
an inlet port for receiving a liquid
   wherein the inlet port comprises a funnel
   wherein liquid is poured into the inlet port
   wherein a vessel of liquid is opened and placed onto the inlet port
   wherein the liquid comprises a beverage (e.g., alcoholic, sports, etc.)
   wherein the liquid comprises medicine
   wherein the liquid comprises baby formula
   wherein the liquid comprises perfume
   wherein the liquid comprises cooking oil
   wherein the liquid comprises ink
   wherein the liquid comprises dye
a valve for controlling liquid flow
a filter for filtering tags
   wherein the filter can move from a filtering position to a verification position
   wherein the filter is moved manually
   wherein the filter is moved automatically
a tag evaluator for verifying a tag
   wherein the tag evaluator optically verifies the tag
   wherein the tag evaluator optically verifies the tag via a punctured hole in the cartridge lid
   wherein the tag evaluator comprises a light source
   wherein the tag evaluator comprises a spectrometer
   wherein the tag evaluator comprises a Fabry-Perot interferometer
   wherein the tag evaluator comprises a microelectromechanical systems interferometer
a receptacle for collecting liquid
a heater for drying the filter
an indicator indicating whether the liquid passed verification.

In various embodiments, a system for evaluating a liquid comprises one or more of the following:
an inlet port for receiving a liquid
   wherein the inlet port comprises a funnel
   wherein liquid is poured into the inlet port
   wherein a vessel of liquid is opened and placed onto the inlet port
   wherein the liquid comprises a beverage (e.g., alcoholic, sports, etc.)
   wherein the liquid comprises a medicine
   wherein the liquid comprises a baby formula
   wherein the liquid comprises a perfume
   wherein the liquid comprises a cooking oil
   wherein the liquid comprises an ink
   wherein the liquid comprises a dye
a separating system for separating tags from the liquid
   wherein the separating system comprises a filter
   wherein the separating system comprises an evaporation system
   wherein the separating system comprises a distillation system
   wherein the separating system comprises a centrifuge system
a tag evaluator for verifying a tag
   wherein the tag evaluator optically verifies the tag
   wherein the tag evaluator optically verifies the tag via a punctured hole in the cartridge lid
   wherein the tag evaluator comprises a light source
   wherein the tag evaluator comprises a spectrometer
   wherein the tag evaluator comprises a Fabry-Perot interferometer
   wherein the tag evaluator comprises a microelectromechanical systems interferometer
   wherein the tag evaluator magnetically verifies the tag
   wherein the tag evaluator electrically verifies the tag
   wherein the tag evaluator chemically verifies the tag
an indicator indicating whether the liquid passed verification.
   wherein the indicator blocks access to the liquid in the event that verification is not passed

In some embodiments, tag recovery may be used to assess blend uniformity of powdered components, such as used in pharmaceutical or nutraceutical solid dosage forms, or various instant liquids, prior to the blend making its way to final product form (e.g. tablet, capsule, cartridge, packet, etc.). Blend uniformity is a function of both the formulation and mixing action. Once the formulation is optimized from a theoretical process standpoint, blend uniformity must be validated during piloting and scale-up, and periodically monitored during manufacture. From a manufacturer's perspective, poor uniformity generates unacceptable amounts of discarded products, resulting in significant loss of revenue. By adding tags into the powdered components prior to mixing, blending uniformity can be assessed by comparing theoretical tag density to measured tag densities from samples taken from various locations within the blend after mixing, and/or after the blend has reached its final product form by taking samples from the beginning, middle, and end of the product run (e.g. analyzing tag count from tablets, capsules, cartridges, or packets produced from a filling operation and comparing the tag count from each sample to the average measured tag density as well as the theoretical tag density). The greater the number of samples, and/or the greater the tag density used to mark the blends, the better the statistics that can be obtained, hence greater confidences can be achieved in the final blend uniformity. Use of tags as a marker to assess blend uniformity can be done for batch and/or continuous in-line processes. In some embodiments, tags may be added to one or more components of the final blend. In some embodiments, tags of different optical signatures may be used to uniquely track the proportion of one or more components. In some embodiments, the measured tag density can be used as an indication of the proper amount of an added ingredient, useful for quality assurance applications, including monitoring products in the field to ensure distributors, secondary marketers or value-added resellers have included the proper amount of component(s) in the final product form. Recovery of tags used to assess blend uniformity, and/or proper concentration at various points of the supply, manufacturing or distribution chain, is possible via the methods outlined above. Note that the recovery and subsequent measurement of tag density may be enhanced by first dissolving the tagged blend-sample in an appropriate solvents(s) and rinsing to remove interfering particles that may obstruct readout of the tags.

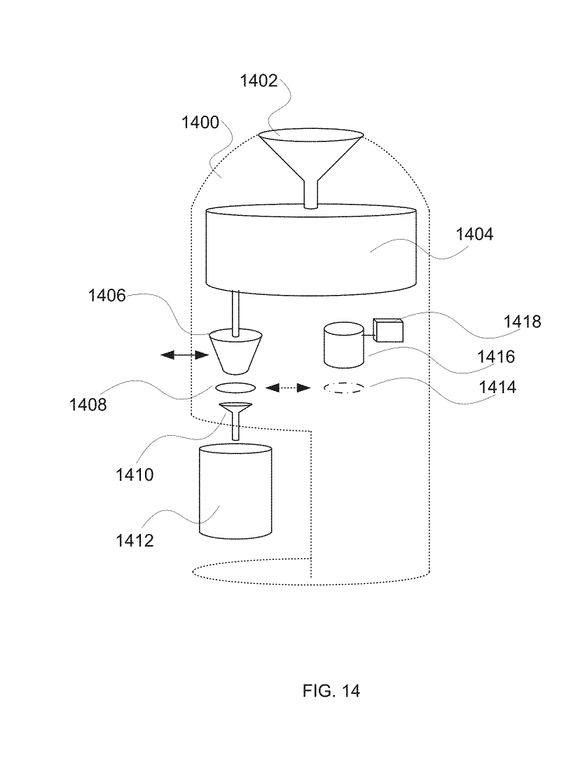

FIG. 14 is a block diagram illustrating an embodiment of a system for identification of a tagged liquid. In some embodiments, the process of FIG. 13 is executed using the device of FIG. 14. In the example shown, device 1400 is used to take in a liquid through aperture 1402 to store temporarily in container 1404 after passing through a funnel. The liquid in container 1404 is selectively fed through to cartridge 1406 (e.g., using a valve and a feeder pipe). Cartridge 1406 with a powder is fed into device 1400 through an aperture (not shown). The liquid and powder (including tags) mix and make a solution that exits out the bottom of cartridge 1406 and flow through filter 1408 to capture funnel and pipe 1410 to capture container 1412 (e.g., a cup). Tags are separated from the solution in Filter 1408. Filter 1408 is moved to location 1414 for detection of the tags using detector 1416. Filter 1408 is in some cases dried (e.g., using a heater or spinning) or in some cases when the tags can be read while still wet there is no drying of filter 1408. Detector 1416 detects tags (e.g., illuminates using a broadband light and measures back-reflected frequencies of light, detects color, detects magnetic fields, detects electromagnetic response, etc.) and indicates to controller 1418 the detected signal. Controller 1418 indicates that the solution or powder are verified. Controller 1418 can compare the detected signal with a known authentic expected signal that is either stored in the device or received via a communication network (e.g., a wireless network, a cellular network, etc.). The controller is able to receive an indication that the liquid is received in the device and that the powder with tags is received (e.g., that bulk powder with tags is received or that a cartridge with powder and tags is received). The controller also is able to cause the separation using a filter of the tags from the solution made from mixing the liquid with the powder and preparing the filter for detection of the tags—for example, by moving a filter so that the solution flows over or through the filter and then moving the filter to prepare the filter and tags for detection by heating or spinning or other drying mechanism. The controller is also able to cause the evaluation of the tags on the filter—for example, by moving the filter or the optical analyzer to be able to analyze the tags on the filter.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A device for identification of a tagged liquid, comprising:
a liquid access port for receiving a liquid;
a powder access port for receiving a powder, wherein the powder includes tags;
a filter for separating one or more tags from a solution of the liquid mixed with the powder; and
an optical analyzer for evaluating the one or more tags to verify the solution.

2. A device as in claim 1, wherein the liquid comprises water.

3. A device as in claim 1, wherein the powder comprises a powder to make one of the following: a baby formula, a coffee, a juice, an energy drink, a protein drink, or a medicine.

4. A device as in claim 1, wherein the powder is contained in a cartridge.

5. A device as in claim 1, wherein the tags comprise one of the following: a rugate filter, a Fabry Perot filter, a duality of rugate and Fabry Perot filters, a non-oxidized silicon tag, a partially-oxidized silicon tag, a fully-oxidized silicon tag, a silicon-nitride tag, or an etched silicon tag with pores.

6. A device as in claim 1, wherein the filter is made of paper.

7. A device as in claim 1, wherein the filter with pores in the range of 20 to 25 microns.

8. A device as in claim 1, wherein the filter is dried using a heater.

9. A device as in claim 1, wherein the filter is dried using a motor to spin the filter.

10. A device as in claim 1, wherein the filter is moved to be evaluated by the optical analyzer.

11. A device as in claim 1, wherein the optical analyzer is moved to be able to evaluate the filter.

12. A device as in claim 1, wherein the optical analyzer includes a light source.

13. A device as in claim 1, wherein the optical analyzer includes a spectrometer.

14. A device as in claim 1, wherein the optical analyzer includes a Fabry-Perot interferometer.

15. A device as in claim 1, wherein blend uniformity is assessed using the optical analyzer.

16. A device as in claim 15, wherein blend uniformity is assessed using a density of detected tags.

17. A device as in claim 15, wherein the tags are of one or more types each associated with a specific powder.

18. A method for identification of a tagged liquid, comprising:
receiving a liquid via a liquid access port;
receiving a powder via a powder access port, wherein the powder includes tags;
separating using a filter one or more tags from a solution of the liquid mixed with the powder; and
evaluating using an optical analyzer the one or more tags to verify the solution.

19. A computer program product for identification of a tagged liquid, the computer program product being embodied in a tangible computer readable storage medium and comprising computer instructions for:
receiving an indication that a liquid is received via a liquid access port;
receiving an indication that a powder is received via a powder access port, wherein the powder includes tags;
causing separation using a filter of one or more tags from a solution of the liquid mixed with the powder; and
causing evaluation using an optical analyzer of the one or more tags to verify the solution.
